(19) United States
(12) Patent Application Publication
(10) Pub. No.: US 2014/0337812 A1
(43) Pub. Date: Nov. 13, 2014

(54) CIRCUIT VERIFICATION METHOD AND CIRCUIT VERIFICATION APPARATUS

(71) Applicant: FUJITSU LIMITED, Kawasaki-shi (JP)

(72) Inventors: SATOSHI MATSUBARA, Machida (JP); HIROYUKI SATO, Kawasaki (JP)

(21) Appl. No.: 14/340,029

(22) Filed: Jul. 24, 2014

Related U.S. Application Data
(63) Continuation of application No. PCT/JP2012/056071, filed on Mar. 9, 2012.

(51) Int. Cl. G06F 17/50

(52) U.S. Cl. CPC G06F 17/5081
USPC 716/111

(57) ABSTRACT

A control section of a circuit verification apparatus acquires waveform data of output in a transient state of a verification target circuit by a circuit simulation and stores the waveform data in a storage section. When the control section detects input to a functional model of the verification target circuit during functional verification performed by the use of the functional model, the control section generates an output signal of the functional model by the use of the waveform data stored in the storage section.

### CROSS-REFERENCE TO RELATED APPLICATION

This application is a continuation application of International Application PCT/JP2012/056071 filed on Mar. 9, 2012 which designated the U.S., the entire contents of which are incorporated herein by reference.

### FIELD

The embodiments discussed herein are related to a circuit verification method and a circuit verification apparatus.

### BACKGROUND

With a recent increase in the number of the functions of semiconductor integrated circuits, many analog circuits, such as an amplifier and an oscillator, and many digital circuits, such as an inverter and a NAND circuit, mingle on one chip.

Top-down design in which after a simple examination of an entire function a circuit for realizing the function is formed is effective in designing such a large-scale chip. With the top-down design the entire function is checked by combining many circuit functions, so a “functional model” which simply represents the function of the circuit is used at first. The functional model indicates the relationship between input and output of the circuit. For example, when input X is given, output Y is uniquely represented by a relational expression or a truth table. When the entire function is verified, an event-driven operation process in which an operation is performed only at the time of a change in input is performed. The function of a high-speed large-scale circuit can be verified by limiting a portion for which an operation is performed.

After the consistency of the entire function is established by the use of a functional model, a circuit at a transistor level is formed on the basis of the functional model. After circuit formation and a layout, a circuit simulation is done in a state closer to an actual device. A characteristic obtained by the circuit simulation is fed back to the functional model and the consistency of the entire function is checked again.
Japanese Laid-open Patent Publication No. 05-303605
Japanese Laid-open Patent Publication No. 10-49555
Japanese Laid-open Patent Publication No. 2007-122589

However, the operation of the actual device includes nonlinear operation (operation including a state which does not depend on input) due to the influence of many internal parameters, parasitic elements formed as a result of a layout, and the like. It is difficult to perform circuit verification at high speed with this nonlinear operation taken into consideration. When the entire function is verified, a part of the functional model may be replaced with a circuit at a transistor level in order to represent the nonlinear operation with great accuracy. In that case, however, a circuit simulation is done during the functional verification. In the circuit simulation, many parameters are used and operations are performed many times. As a result, the nonlinear operation is represented with great accuracy. However, the number of times operations are performed increases, so it takes a long time to perform the functional verification.

As stated above, it is difficult to perform at high speed circuit verification in which the operation of the actual device is reflected.

### SUMMARY

According to an aspect, there is provided a circuit verification method which makes a processor acquire waveform data of output in a transient state of a verification target circuit by a circuit simulation and store the waveform data in a memory and generate, at the time of detecting input to a functional model of the verification target circuit during functional verification performed by the use of the functional model, an output signal of the functional model by the use of the waveform data stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates examples of a circuit verification method and a circuit verification apparatus according to a first embodiment;

FIG. 2 illustrates an example of the hardware of a circuit verification apparatus according to a second embodiment;

FIG. 3 is a flow chart of a process performed by the use of a circuit verification method according to the second embodiment;

FIG. 4 is a flow chart of an example of a circuit simulation result extraction process;

FIG. 5 indicates an example of a functional model;

FIG. 6 is a timing chart of examples of a circuit simulation result and a functional simulation result;

FIG. 7 indicates an example of the storage of waveform data and output differential data acquired and an example of a database list;

FIG. 8 is a flow chart of an example of a functional verification process;

FIG. 9 is a timing chart of an example of correction of a function operation result;

FIG. 10 is a flow chart of an example of a functional verification process in a modification of the second embodiment;

FIG. 11 is a timing chart of a modification of correction of the result of a functional operation;

FIG. 12 is a flow chart of an example of a tendency data extraction process;

FIG. 13 illustrates an example of a verification target circuit;

FIG. 14 is a timing chart of an example of a circuit simulation result;

FIG. 15 indicates examples of calculated tendency data;

FIG. 16 indicates an example of a code of a functional model after update;

FIG. 17 is a flow chart of an example of a functional verification process in a circuit verification method according to a third embodiment;

FIG. 18 indicates an example of a parameter determination method in which plural operating conditions are taken into consideration;

FIG. 19 indicates an example of a waveform data correction process; and

FIG. 20 indicates an example of a comparison between waveform data after correction obtained by the circuit verification method according to the third embodiment and a waveform obtained by a circuit simulation.

### DESCRIPTION OF EMBODIMENTS

Embodiments will now be described with reference to the accompanying drawings, wherein like reference numerals refer to like elements throughout.

### First Embodiment

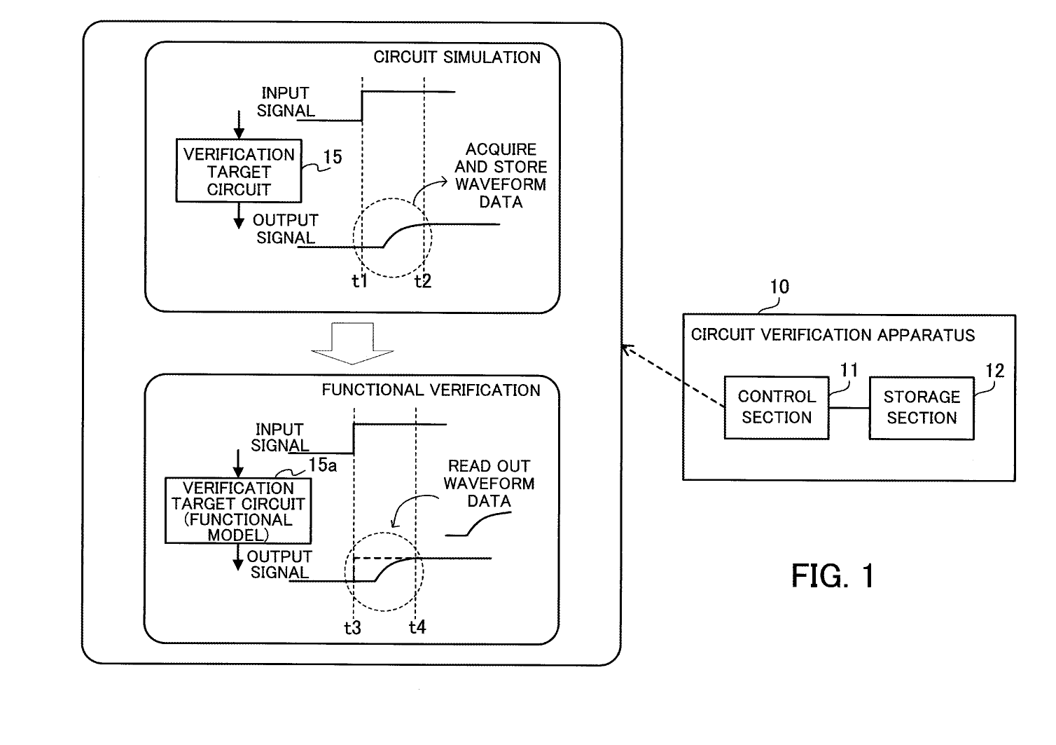

FIG. 1 illustrates examples of a circuit verification method and a circuit verification apparatus according to a first embodiment.

A circuit verification apparatus 10 includes a control section 11 and a storage section 12.

The control section 11 performs a circuit simulation and functional verification. A circuit simulation is performed by the use of, for example, SPICE (Simulation Program with Integrated Circuit Emphasis). When the control section 11 performs a circuit simulation, the control section 11 acquires waveform data of output in a transient state of a verification target circuit 15 and stores the waveform data in the storage section 12.

The control section 11 performs a circuit simulation on the basis of a circuit diagram (which is also referred to as a schematic), the specifications (including an input pattern and setup time), and the like of the verification target circuit 15. Output in a transient state of the verification target circuit 15 means, for example, an output signal in a state in which its level makes a transition. According to a timing chart indicated in FIG. 1, waveform data including a portion in which an output signal rises is acquired.

In order to acquire waveform data in a transient state, the control section 11 acquires the values of an output signal, for example, for the setup time prescribed in the specifications from the timing at which an input signal changes. In the example of FIG. 1, the control section 11 acquires waveform data from timing t1 to timing t2.

With functional verification, the verification target circuit 15 is represented as a functional model 15a and an event-driven operation process is performed according to the input pattern prescribed in the specifications. With the circuit verification method according to the first embodiment, however, when input to the functional model 15a is provided, the control section 11 generates an output signal of the functional model 15a by the use of waveform data stored in the storage section 12.

As indicated on a timing chart of FIG. 1, for example, when the level of an input signal changes (when an event occurs) (timing t3), the control section 11 reads out waveform data from the storage section 12. The control section 11 then uses the waveform data it reads out in place of waveform data from the timing t3 to timing t4 (indicated by a dashed line) for which functional verification is performed to generate an output signal of the functional model 15a.

Waveform data of output in a transient state of a verification target circuit acquired by doing a circuit simulation is used in this way for functional verification. By doing so, circuit verification in which the operation of an actual device is reflected is performed. Furthermore, when functional verification is performed, the stored waveform data in a transient state is read out and is used for generating an output signal. Accordingly, there is no need to replace a functional model with a circuit at a transistor level for doing a circuit simulation. This increases circuit verification speed.

For example, the above circuit verification method is more suitable to verify a semiconductor device including an analog circuit for which a more accurate voltage value is required than to verify a semiconductor device including a digital circuit which operates at L (Low) and H (High) voltage levels, that is to say, at two voltage levels.

The value of an output signal after waveform data read-out time may also be corrected or waveform data may be corrected according to operating conditions (such as input voltage) at the time of functional verification. By doing so, circuit verification in which the operation of an actual device is reflected with greater accuracy is performed. Such a correction process will be described in the following embodiments.

Furthermore, in the above example acquired waveform data in a transient state corresponds to the rising portion of the output signal. However, the control section 11 may acquire a falling portion of the output signal for functional verification.

In addition, the control section 11 may be realized by a program executed by the use of a CPU (Central Processing Unit) and a RAM (Random Access Memory).

### Second Embodiment

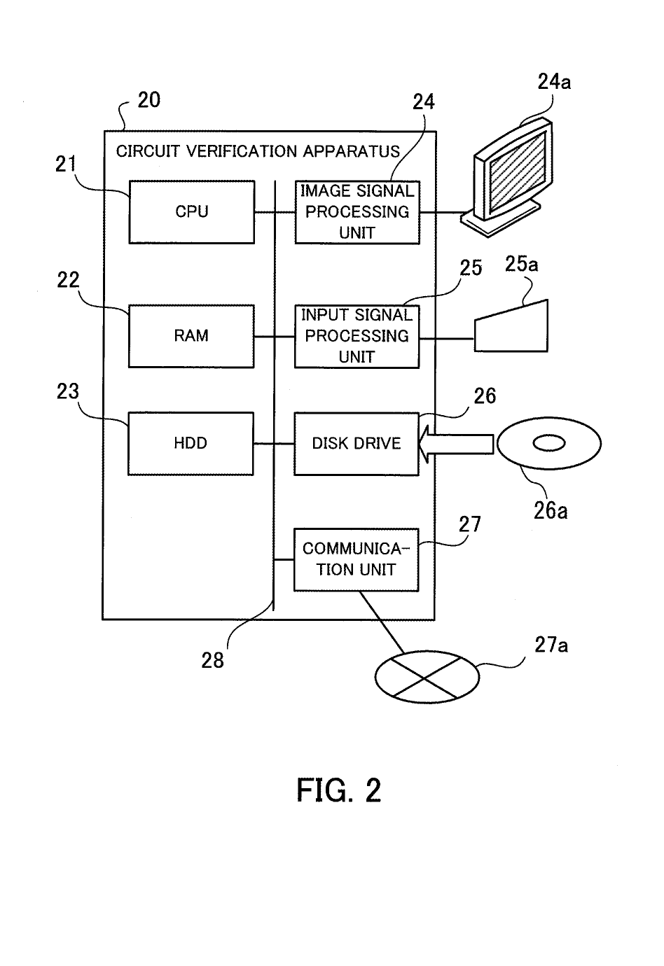

FIG. 2 illustrates an example of the hardware of a circuit verification apparatus according to a second embodiment.

A circuit verification apparatus 20 includes a CPU 21, a RAM 22, a HDD (Hard Disk Drive) 23, an image signal processing unit 24, an input signal processing unit 25, a disk drive 26, and a communication unit 27. These units are connected to a bus 28 in the circuit verification apparatus 20.

The CPU 21 is an operation unit which controls information processing on the circuit verification apparatus 20. The CPU 21 reads out at least a part of a program or data stored in the HDD 23, expands it in the RAM 22, and executes the program. The circuit verification apparatus 20 may include a plurality of operation units to perform distributed information processing.

The RAM 22 is a volatile memory which temporarily stores a program or data that the CPU 21 handles. The circuit verification apparatus 20 may include a memory which differs from a RAM in type, or include a plurality of memories.

The HDD 23 is a nonvolatile storage unit which stores programs, such as an OS (Operating System) program and application programs, and data used for information processing. The HDD 23 reads from or writes to a built-in magnetic disk in accordance with an instruction from the CPU 21. The circuit verification apparatus 20 may include a nonvolatile storage unit (such as a SSD (Solid State Drive)) other than a HDD or include a plurality of storage units.

In accordance with an instruction from the CPU 21, the image signal processing section 24 outputs an image to a display 24a connected to the circuit verification apparatus 20. A CRT (Cathode Ray Tube) display, a liquid crystal display, or the like is used as the display 24a.

The input signal processing section 25 acquires an input signal from an input device 25a connected to the circuit verification apparatus 20, and outputs it to the CPU 21. A pointing device, such as a mouse or a touch panel, a keyboard, or the like is used as the input device 25a.

The disk drive 26 is a drive unit which reads a program or data recorded on a record medium 26a. A magnetic disk, such as a FD (Flexible Disk) or a HDD, an optical disk, such as a CD (Compact Disc) or a DVD (Digital Versatile Disc), a MO (Magneto-Optical disk), or the like is used as the record medium 26a. For example, the disk drive 26 stores a program or data which it reads from the record medium 26a in the RAM 22 or the HDD 23 in accordance with an instruction from the CPU 21.

The communication unit 27 is a communication interface which is connected to a network 27a and which performs communication. The communication unit 27 may be connected to the network 27a by wire or radio. That is to say, the communication unit 27 may be a wired communication interface or a radio communication interface.

A processing function of this embodiment is realized by adopting the above hardware configuration.

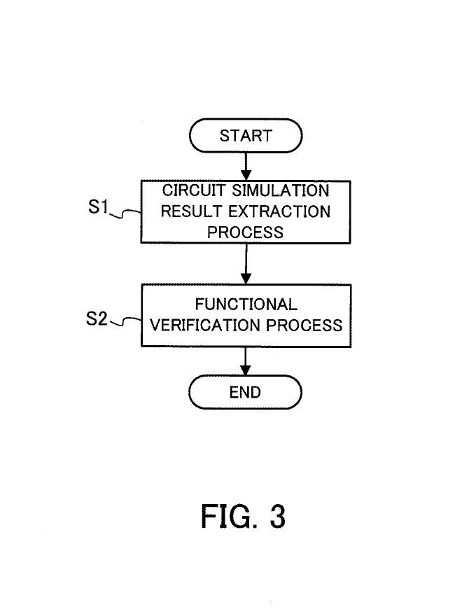

FIG. 3 is a flow chart of a process performed by the use of a circuit verification method according to the second embodiment.

With a circuit verification method according to the second embodiment a circuit simulation result extraction process (step S1) for acquiring, for example, waveform data of output in a transient state of a verification target circuit by doing a circuit simulation and a functional verification process (step S2) are performed. Steps S1 and S2 will now be described in detail.

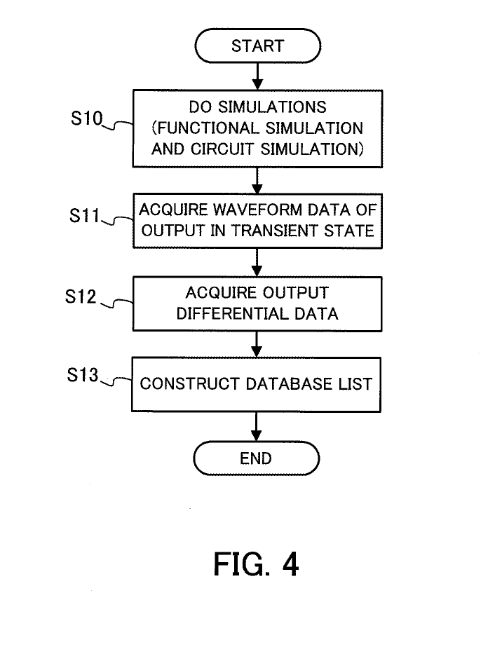

FIG. 4 is a flow chart of an example of the circuit simulation result extraction process.

(Step S10) The circuit verification apparatus 20 does simulations under the control of the CPU 21. The simulations include a functional simulation and a circuit simulation.

The circuit verification apparatus 20 does the functional simulation by the use of a functional model, the specifications (such as an input pattern), and the like of a verification target circuit stored in advance in the HDD 23. The functional model is described in a hardware description language such as Verilog.

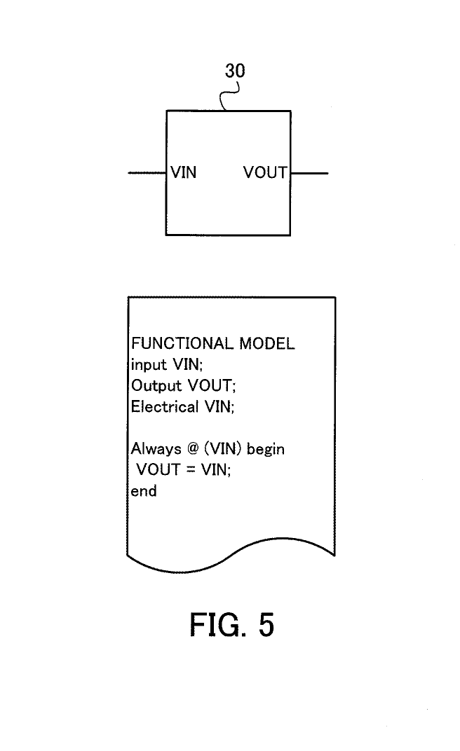

FIG. 5 indicates an example of a functional model.

FIG. 5 indicates an example of the description of a functional model of a circuit (such as a buffer circuit) 30 which outputs an input value in its original condition. The declaration that an input terminal and an output terminal are VIN and VOUT respectively is made first in this description. “Electrical VIN” indicates that VIN has analog current and voltage values. The description “Always @(VIN) begin/VOUT=VIN” indicates that when VIN changes, VOUT is made equal to VIN.

A determined input pattern is applied to the above functional model and a functional simulation is done.

On the other hand, the circuit verification apparatus 20 does the circuit simulation by the use of a circuit diagram, the specifications (such as an input pattern), and the like of the verification target circuit stored in advance in the HDD 23. The circuit verification apparatus 20 does the circuit simulation by the use of the SPICE or the like.

(Step S11) The CPU 21 acquires waveform data of output in a transient state from a circuit simulation result.

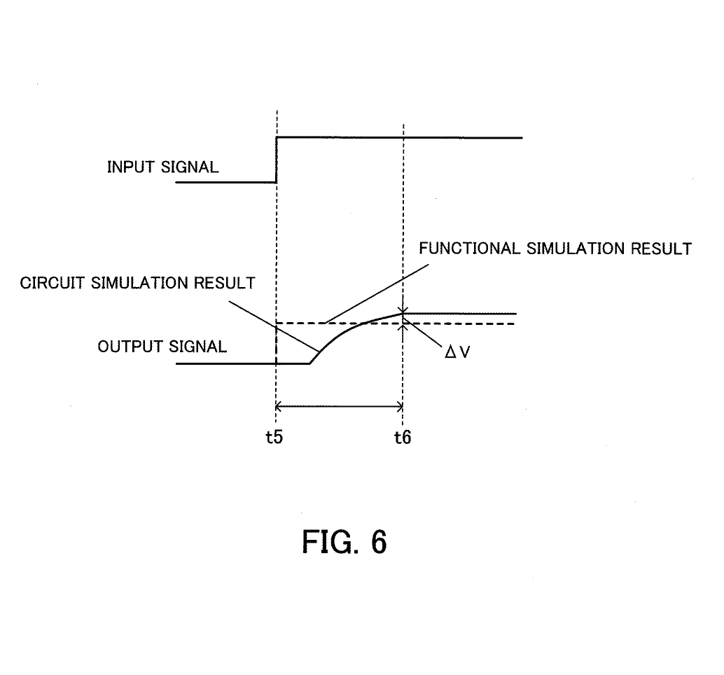

FIG. 6 is a timing chart of examples of a circuit simulation result and a functional simulation result.

FIG. 6 indicates a circuit simulation result (indicated by a solid line) and a functional simulation result (indicated by a dashed line) of an output signal obtained at the time of applying to the buffer circuit an input signal which rises at timing t5.

In step S11, waveform data, which is a circuit simulation result, is acquired, for example, for setup time prescribed in the specifications from the timing at which the input signal changes. In the example of FIG. 6, waveform data, which is a circuit simulation result, of an output signal is acquired from the timing t5 to timing t6. At the timing (timing t6) at which acquisition of the waveform data is ended, there is a difference of ΔV in voltage between the circuit simulation result and the functional simulation result.

Time for which waveform data is acquired is not limited to setup time and may be time from the timing at which an input signal changes to the timing at which a change in output signal ends.

For example, when the difference between data acquired time X (or X points) before and data currently acquired is smaller than a determined threshold or when the difference between data currently acquired and an assumed output value (expected value) is smaller than or equal to Y percent of the assumed output value (expected value), the determination that a change in output signal has ended is made.

(Step S12) The CPU 21 acquires from the circuit simulation result and the functional simulation result output differential data which is a value differential between them at the timing at which acquisition of the waveform data is ended. In the example of FIG. 6, ΔV is the output differential data.

The waveform data and the output differential data acquired in steps S11 and S12, respectively, are stored in, for example, the HDD 23.

With the circuit verification method according to the second embodiment waveform data and output differential data are acquired according to, for example, operating conditions of each verification target circuit. For example, if an input signal has plural voltage values, then waveform data of output in a transient state and output differential data corresponding to each voltage value are acquired.

(Step S13) The CPU 21 constructs a database list.

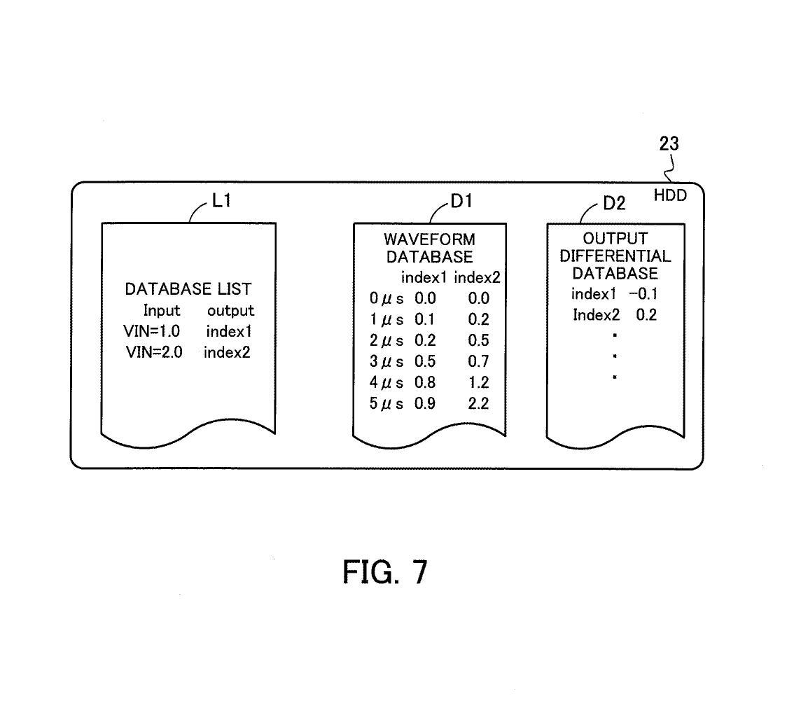

FIG. 7 indicates an example of the storage of waveform data and output differential data acquired and an example of a database list.

In the example of FIG. 7, a waveform database D1 for managing acquired waveform data and an output differential database D2 for managing acquired output differential data are created in the HDD 23. As illustrated in FIG. 7, a database list L1 for managing these databases is also constructed in, for example, the HDD 23.

An index which designates waveform data or output differential data to be applied according to a voltage value inputted to a verification target circuit is indicated in the database list L1. In the examples of FIG. 7, if VIN=1.0 (V), waveform data and output differential data designated by index1 are applied. If VIN=2.0 (V), waveform data and output differential data designated by index2 are applied.

Acquired waveform data is indicated in the waveform database D1 as a voltage value which changes with time elapsed after the timing at which acquisition of the waveform data is begun. Waveform data designated by index1 is acquired at the time of the voltage value of an input signal being VIN=1.0 (V). Waveform data designated by index2 is acquired at the time of the voltage value of an input signal being VIN=2.0 (V). In the example of FIG. 7, waveform data is acquired for 5 μs.

Output differential data designated by index1 (voltage value of an input signal is VIN=1.0 (V)) and output differential data designated by index2 (voltage value of an input signal is VIN=2.0 (V)) are managed in the output differential database D2.

With a circuit for which VIN=VOUT, a functional simulation result is VOUT=1.0 (V) when VIN=1.0 (V). A functional simulation result is VOUT=2.0 (V) when VIN=2.0 (V). Furthermore, in the example of FIG. 7, a voltage value of the waveform data, which is a circuit simulation result, at the timing at which acquisition of the waveform data is ended (voltage value at the time of the above time elapsed being 5 μs) is 0.9 (V) when VIN=1.0 (V). A voltage value of the acquired waveform data, which is the circuit simulation result, at the timing at which acquisition of the waveform data is ended is 2.2 (V) when VIN=2.0 (V).

Accordingly, output differential data is −0.1 (V) when VIN=1.0 (V). Output differential data is 0.2 (V) when VIN=2.0 (V).

In the functional verification process (step S2 of FIG. 3), functional verification is performed by the use of waveform data or output differential data stored in the above waveform database D1 or output differential database D2.

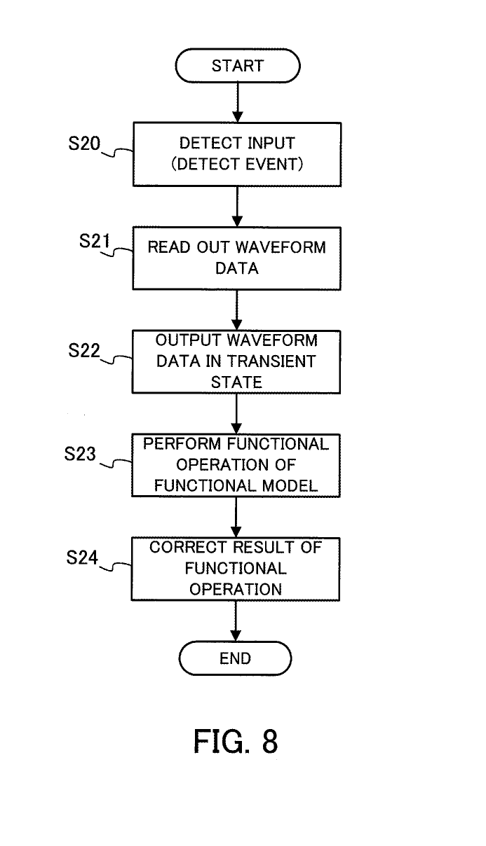

FIG. 8 is a flow chart of an example of the functional verification process.

An input signal of a determined pattern is given to one or more verification target circuits (functional models) under the control of the CPU 21. By doing so, functional verification is performed. The following process is performed on each functional model.

(Step S20) The CPU 21 detects input to a functional model (event).

(Step S21) The CPU 21 reads out from, for example, the HDD 23 waveform data of output in a transient state corresponding to an operating condition. For example, when the input VIN=2.0 (V) to the circuit 30 of FIG. 5 for which VIN=VOUT is detected, waveform data designated by index2 is read out from the waveform database D1 indicated in FIG. 7.

(Step S22) The CPU 21 outputs the waveform data of the output in a transient state which it reads out as an output signal of the functional model.

(Step S23) The CPU 21 performs a functional operation of the functional model. With the circuit 30 illustrated in FIG. 5, for example, the CPU 21 performs the functional operation VIN=VOUT. An event-driven functional operation is performed after a waveform data application period. By doing so, high-speed functional verification is guaranteed.

(Step S24) The CPU 21 reads out from, for example, the HDD 23 output differential data corresponding to the operating condition, and corrects the result of the functional operation by the use of the output differential data it reads out.

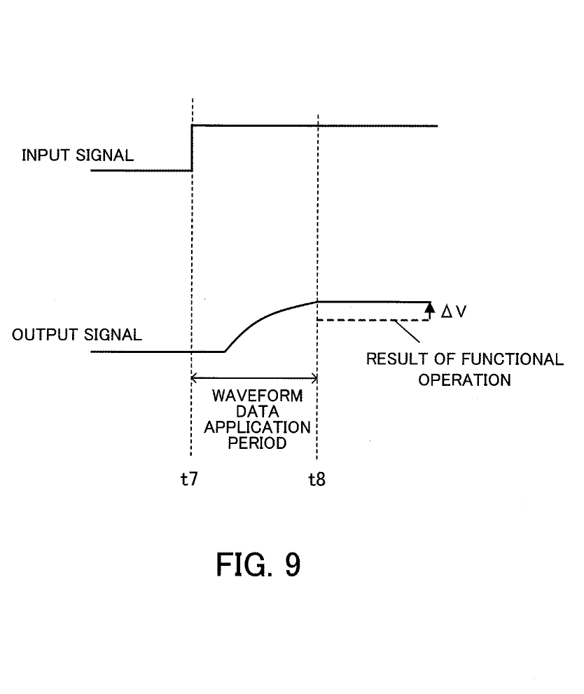

FIG. 9 is a timing chart of an example of correction of the result of a function operation. FIG. 9 indicates the states of an input signal and an output signal of the functional model which is indicated in FIG. 5 and which performs the functional operation VIN=VOUT.

Waveform data read out from the waveform database D1 is applied as an output signal of the functional model, for example, during a period from timing t7 to timing t8. The result of the functional operation of the functional model is outputted from the timing t8 at which application of the waveform data read out is ended. There may be a voltage difference (ΔV) between a voltage value of the waveform data at this time and a voltage value which is the result of the functional operation. ΔV is equal to the output differential data read out in step S24. Accordingly, the CPU 21 adds the output differential data to or subtracts the output differential data from the voltage value which is the result of the functional operation. This makes it possible to make the voltage value, which is the result of the functional operation, equal to the voltage value of the waveform data at the timing t8.

In the example of FIG. 7, for example, when the input VIN=2.0 (V) to the functional model is detected, a voltage value of the waveform data is greater than a voltage value (VOUT=VIN=2.0 (V)), which is the result of the functional operation, by 0.2 (V) at the timing at which acquisition of the waveform data is ended. Accordingly, the CPU 21 adds 0.2 (V), which is the output differential data designated by index2, to the result of the functional operation to obtain 2.2 (V). By doing so, the CPU 21 can correct the result of the functional operation so as to make the result of the functional operation equal to the voltage value of the waveform data obtained by a circuit simulation.

As has been described, according to the circuit verification apparatus 20 and the circuit verification method according to the second embodiment waveform data of output in a transient state of a verification target circuit acquired by doing a circuit simulation is used for functional verification. By doing so, circuit verification in which the operation of an actual device is reflected is performed. In addition, when functional verification is performed, stored waveform data in a transient state is read out and is used for generating an output signal. As a result, there is no need to replace a functional model with a circuit at a transistor level for doing a circuit simulation. This increases circuit verification speed.

Furthermore, according to the circuit verification apparatus 20 and the circuit verification method according to the second embodiment the result of a functional operation after application of waveform data is corrected by the use of output differential data. Accordingly, circuit verification in which the operation of an actual device is reflected with greater accuracy is performed.

(Modification)

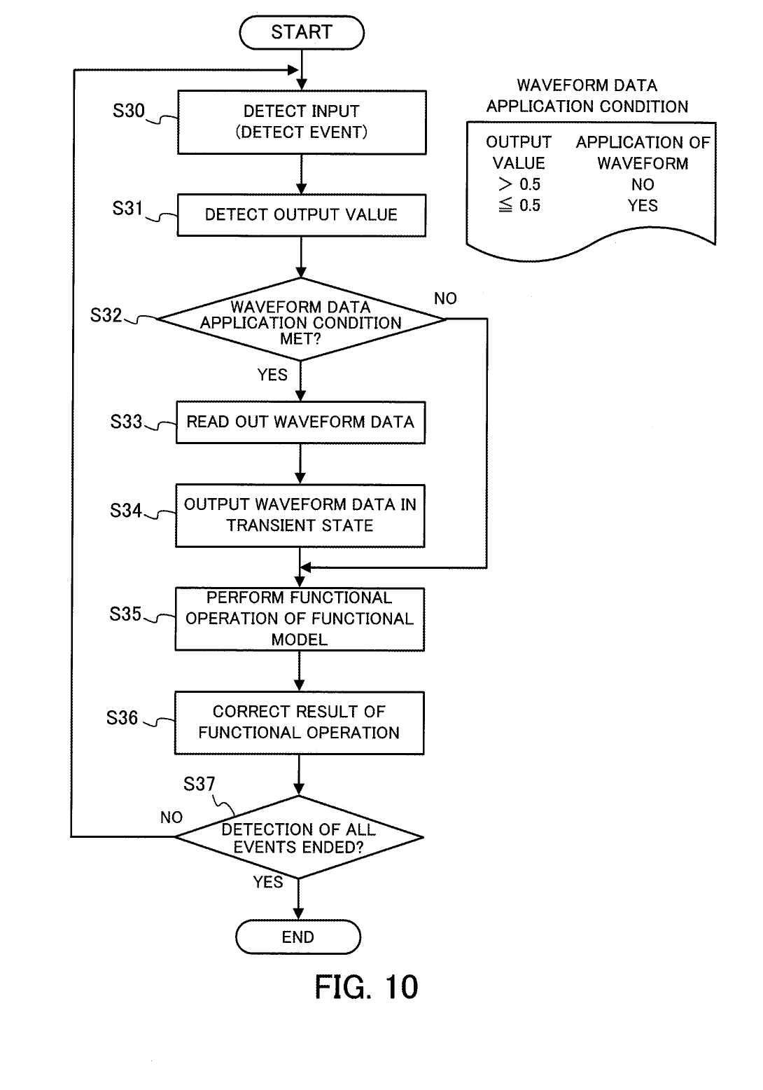

FIG. 10 is a flow chart of an example of a functional verification process in a modification of the second embodiment.

(Step S30) The CPU 21 detects input to a functional model (event).

(Step S31) The CPU 21 detects an output value of the functional model.

(Step S32) The CPU 21 determines whether or not the output value of the functional model meets a waveform data application condition. FIG. 10 indicates an example of a waveform data application condition. It is assumed that the waveform data application condition indicated in FIG. 10 is adopted. If the output value of the functional model is greater than 0.5 (V), then waveform data is not applied as an output value of the functional model. If the output value of the functional model is smaller than or equal to 0.5 (V), then waveform data is applied as an output value of the functional model. Such a waveform data application condition is stored in, for example, the HDD 23 and is read out by the CPU 21.

If the output value of the functional model meets the waveform data application condition, then the CPU 21 proceeds to step S33. For example, if the waveform data application condition indicated in FIG. 10 is adopted and the output value of the functional model is smaller than or equal to 0.5 (V), then the CPU 21 proceeds to step S33. If the output value of the functional model does not meet the waveform data application condition, then the CPU 21 proceeds to step S35.

(Step S33) The CPU 21 reads out waveform data of output in a transient state of a verification target circuit from, for example, the HDD 23.

(Step S34) The CPU 21 outputs the waveform data it reads out as an output signal of the functional model.

(Step S35) The CPU 21 performs a functional operation of the functional model.

(Step S36) The CPU 21 reads out output differential data from, for example, the HDD 23 and corrects the result of the functional operation by the use of the output differential data it reads out.

(Step S37) The CPU 21 determines whether or not the detection of all events has ended. If all the events are detected, then the functional verification process ends. If any event remains to be detected, then process is repeated from step S30.

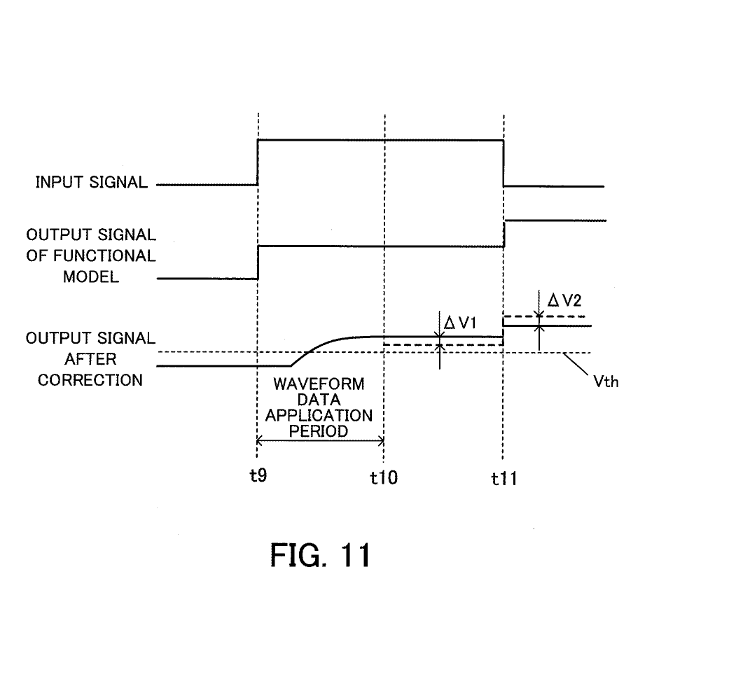

FIG. 11 is a timing chart of a modification of correction of the result of a functional operation. FIG. 11 indicates examples of an input signal, an output signal of a functional model, and an output signal after correction of a circuit for which an output signal rises to a level at the rising of the input signal and for which the output signal rises to a higher level at the falling of the input signal.

Vth is a threshold for determining whether to apply waveform data. With the example of a waveform data application condition indicated in FIG. 10, for example, Vth is 0.5 (V).

When a first event (rising of an input signal) is detected at timing t9, waveform data acquired by doing a circuit simulation is read out from, for example, the HDD 23 and is applied as an output signal of a functional model. When a waveform data application period ends (timing t10), the above steps S35 and S36 are performed. As a result, the result of a functional operation of the functional model indicated by a dashed line is corrected by the use of output differential data and is increased by ΔV1. By doing so, a value of the waveform data at the timing t10 is obtained.

When a new event (falling of the input signal) is detected at timing t11, an output value of the functional model at that time is detected and the above step S32 is performed. In the example of FIG. 11, the output value of the functional model is greater than Vth. Accordingly, application of the waveform data to the output signal of the functional model is restricted and the above steps S35 and S36 are performed. In the above step S36, the result of the functional operation of the functional model indicated by a dashed line is corrected by the use of output differential data found in advance, and is decreased by ΔV2. By doing so, a value of the waveform data at the timing t11 is obtained.

According to the above functional verification process, a region to which waveform data acquired by doing a circuit simulation is applied is limited. For example, a change in output signal of a verification target circuit may be slight in a region in which an output value of a functional model is greater than Vth, so that nonlinear operation of an actual device is not taken into consideration. In that case, there is no need to read waveform data acquired by doing a circuit simulation. This increases verification speed.

### Third Embodiment

With the circuit verification method according to the second embodiment waveform data of output in a transient state of a verification target circuit is acquired according to operating conditions (such as input voltage values) by doing a circuit simulation. With the following circuit verification method according to a third embodiment tendency data indicative of the tendency of a change of waveform data which is a circuit simulation result obtained on another operating condition in respect to waveform data which is a circuit simulation result obtained on a reference operating condition is used. Accordingly, the following tendency data extraction process is performed.

A tendency data extraction process is performed under the control of the CPU 21 in the circuit simulation result extraction process (step S1 of FIG. 3) after waveform data of an output signal found on a reference operating condition (hereinafter referred to as a reference output signal) is acquired. When waveform data is acquired by doing a circuit simulation, sampling time of the waveform data and time from the beginning of a change in input signal of a verification target circuit to the beginning of a change in output signal of the verification target circuit (delay time) are also acquired.

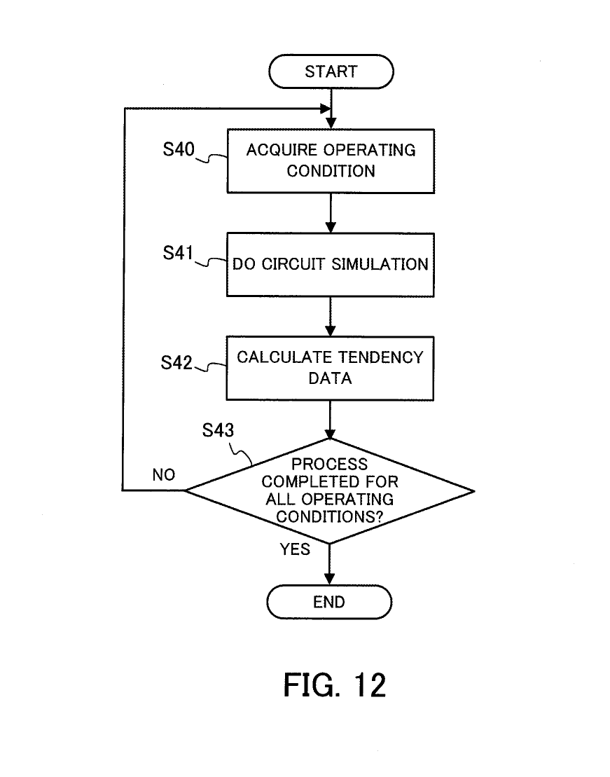

FIG. 12 is a flow chart of an example of a tendency data extraction process.

(Step S40) First the CPU 21 acquires one or more operating conditions regarding a verification target circuit. Operational conditions are input voltage of the verification target circuit, power-supply voltage, temperature, a load value, a process parameter, and the like. An operating condition may be stored in advance in, for example, the HDD 23 or be inputted from the input device 25a by a user of the circuit verification apparatus 20.

(Step S41) A circuit simulation of the verification target circuit is done under the control of the CPU 21 on the acquired operating condition(s). The CPU 21 acquires from a circuit simulation result information (such as a voltage value and time) at a point (hereinafter referred to as a singular point) of an output signal of the verification target circuit at which a maximum or minimum change occurs.

A singular point at which a maximum change occurs in an output signal is, for example, a point at which the output signal begins to change from a L level to a H level (or from a H level to a L level). A singular point at which a minimum change occurs in an output signal is, for example, a point at which a change in the output signal ends.

When step S41 is performed, output differential data which is a value differential between the circuit simulation result and a functional simulation result may be acquired according to operating conditions and be stored in, for example, the HDD 23. This is described in the circuit verification method according to the second embodiment.

(Step S42) The CPU 21 calculates tendency data from information regarding a singular point of the reference output signal and the information regarding the singular point of the output signal obtained on the acquired operating condition.

Tendency data is, for example, of the following three types. Tendency data of the first type is the ratio of an output value (voltage value, in the following examples) at a point at which a change in the waveform of the reference output signal ends to a voltage value at a point at which a change in the waveform of the output signal obtained on the acquired operating condition ends. Tendency data of the second type is the ratio of time from a point at which a change in the waveform of an input signal begins to a point at which a change in the waveform of the reference output signal begins to time from the point at which a change in the waveform of the input signal begins to a point at which a change in the waveform of the output signal obtained on the acquired operating condition begins. That is to say, tendency data of the second type is a delay time ratio. Tendency data of the third type is the ratio of time from the point at which a change in the waveform of the reference output signal begins to the point at which a change in the waveform of the reference output signal ends to time from the point at which a change in the waveform of the output signal obtained on the acquired operating condition begins to the point at which a change in the waveform of the output signal obtained on the acquired operating condition ends. That is to say, tendency data of the third type is a setup time ratio.

As stated above, tendency data is calculated from information at a singular point (such as a point at which a change in the waveform begins or ends) of the output signal of the verification target circuit at which a maximum or minimum change occurs. By limiting in this way points from which tendency data is calculated, the number of times a calculation is performed can be reduced.

(Step S43) The CPU 21 determines whether or not a tendency data calculation process has been completed for all operating conditions stored in, for example, the HDD 23 (or inputted by a user). If the CPU 21 determines that a tendency data calculation process has been completed for all the operating conditions, then the CPU terminates the tendency data extraction process. If the CPU 21 determines that a tendency data calculation process has not been completed for all the operating conditions, then the CPU 21 repeats the process from step S40.

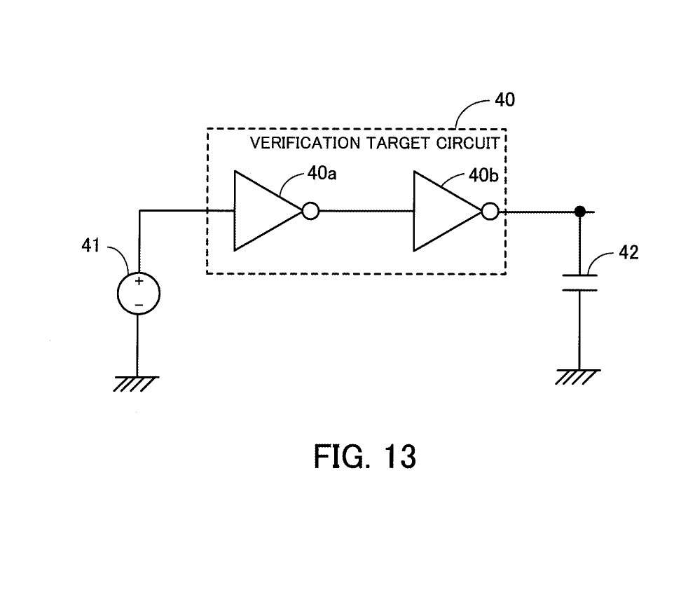

FIG. 13 illustrates an example of a verification target circuit.

A verification target circuit 40 illustrated in FIG. 13 is, for example, a buffer circuit including two inverters 40a and 40b connected in series. An input signal is supplied from a pulse signal generator 41 to the verification target circuit 40. Furthermore, a capacitance 42 is connected as a load to an output terminal of the inverter 40b.

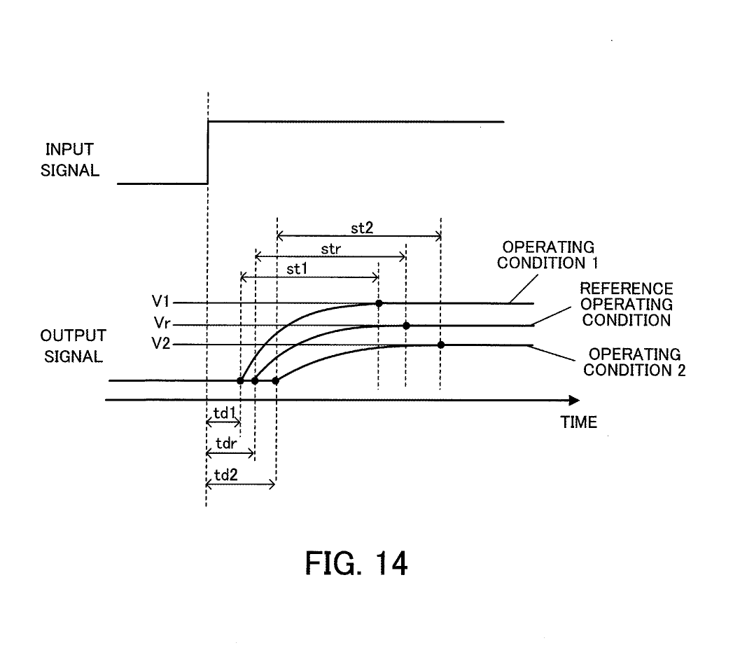

FIG. 14 is a timing chart of an example of a circuit simulation result. The states of an input signal to the verification target circuit 40 illustrated in FIG. 13 and output signals from the verification target circuit 40 obtained on three operating conditions are indicated.

In comparison with time (delay time tdr) from the rising of an input signal to the beginning of a change in reference output signal obtained on a reference operating condition, delay time td1 for an output signal obtained on operating condition 1 is short. In addition, in comparison with the delay time tdr for the reference output signal, delay time td2 for an output signal obtained on operating condition 2 is long.

Furthermore, in comparison with setup time str for the reference output signal, setup time st1 for the output signal obtained on operating condition 1 is short and setup time st2 for the output signal obtained on operating condition 2 is long.

In addition, in comparison with a voltage value Vr at a point at which a change in the waveform of the reference output signal ends, a voltage value V1 at a point at which a change in the waveform of the output signal obtained on operating condition 1 ends is large, and a voltage value V2 at a point at which a change in the waveform of the output signal obtained on operating condition 2 ends is small.

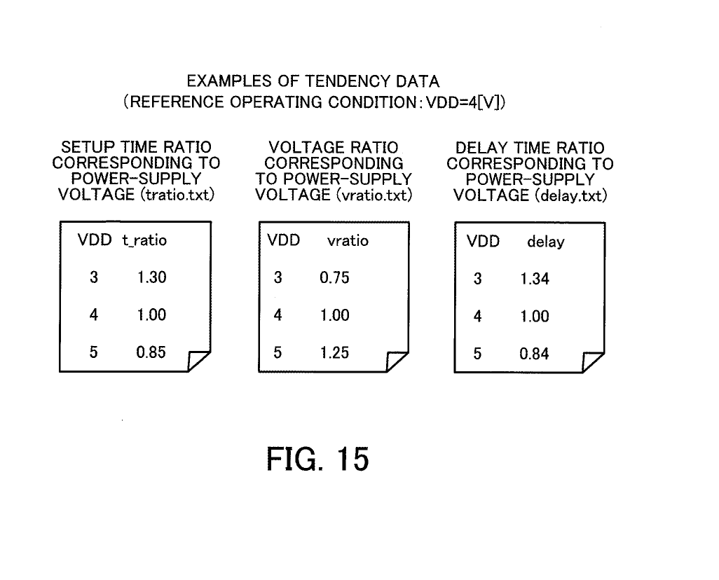

FIG. 15 indicates examples of calculated tendency data. FIG. 15 indicates examples of tendency data of three types calculated at the time of a reference operating condition being power-supply voltage VDD=4 (V).

Tendency data of the first type is a setup time ratio corresponding to power-supply voltage. FIG. 15 indicates that a setup time ratio (t_ratio) obtained at the time of VDD being 4 (V) is 1.00. In this case, FIG. 15 indicates that t_ratio corresponding to the operating condition VDD=3 (V) is 1.30 and that t_ratio corresponding to the operating condition VDD=5 (V) is 0.85.

Tendency data of the second type is a voltage ratio corresponding to power-supply voltage, that is to say, the ratio of a voltage value at a point at which a change in the waveform of an output signal obtained at the time of VDD being 4 (V) ends to a voltage value at a point at which a change in the waveform of an output signal obtained at the time of VDD being another value ends. FIG. 15 indicates that a voltage ratio (vratio) obtained at the time of VDD being 4 (V) is 1.00. In this case, FIG. 15 indicates that vratio corresponding to the operating condition VDD=3 (V) is 0.75 and that vratio corresponding to the operating condition VDD=5 (V) is 1.25.

Tendency data of the third type is a delay time ratio corresponding to power-supply voltage. FIG. 15 indicates that a delay time ratio (delay) obtained at the time of VDD being 4 (V) is 1.00. In this case, FIG. 15 indicates that (delay) corresponding to the operating condition VDD=3 (V) is 1.34 and that (delay) corresponding to the operating condition VDD=5 (V) is 0.84.

The above tendency data is stored in, for example, the HDD 23 as a text file or the like. In the examples of FIG. 15, a setup time ratio based on power-supply voltage is stored under the file name of “tratio.txt”, a voltage ratio based on power-supply voltage is stored under the file name of “vratio.txt”, and a delay time ratio based on power-supply voltage is stored under the file name of “delay.txt”.

After the CPU 21 terminates the above tendency data extraction process, the CPU 21 updates a functional model of the verification target circuit.

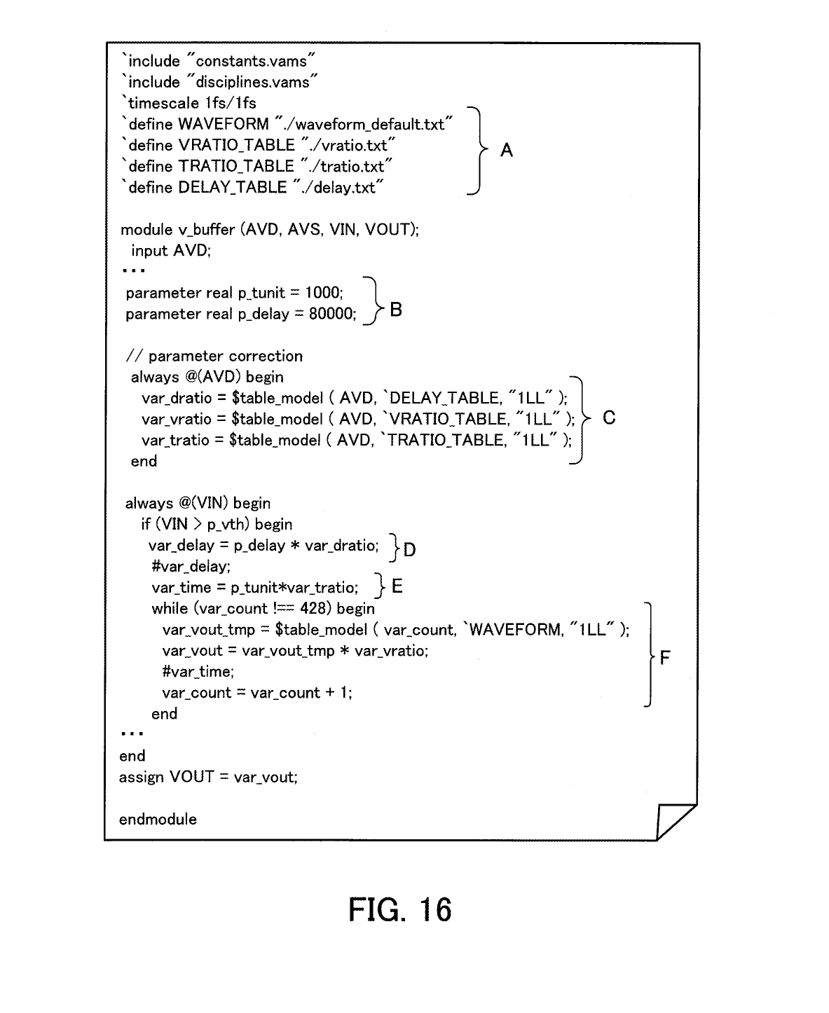

FIG. 16 indicates an example of a code of a functional model after update. FIG. 16 indicates an example of a functional model after update of the verification target circuit 40 illustrated in FIG. 13.

In a code portion A, a file (waveform_default.txt) of waveform data of a reference output signal and the tendency data files indicated in FIG. 15 are designated.

In a code portion B, sampling time (p_tunit) of the waveform data of the reference output signal and delay time (p_delay) of the reference output signal are designated.

In a code portion C, parameters (var_dratio, var_vratio, and var_tratio) for changing the waveform data of the reference output signal on the basis of tendency data are calculated. A value other than a power-supply voltage value (in FIG. 16, the use of analog power supply is assumed and power-supply voltage is described as “AVD”) applied at the time of tendency data extraction may be designated at the time of functional verification, so the parameters are found, for example, by performing a linear interpolation of tendency data values.

In a code portion D, the amount of a delay (p_delay) of the reference output signal and the parameter var_dratio found in the code portion C are multiplied together to find the amount of a delay (var_delay) of waveform data of an output signal newly generated on a designated operating condition.

In a code portion E, the sampling time (p_tunit) of the waveform data of the reference output signal and the parameter var_tratio found in the code portion C are multiplied together. As a result, sampling time (var_time) of the waveform data of the output signal generated on the designated operating condition is found.

In a code portion F, the value of a change in voltage (var_vout_temp) between data points of the waveform data of the reference output signal and the parameter var_vratio found in the code portion C are multiplied together. As a result, the value of a change in voltage (var_vout) between data points of the waveform data of the output signal generated on the designated operating condition is found.

A functional model after update is stored in, for example, the HDD 23.

After the CPU 21 terminates the update of a functional model, the CPU 21 performs a functional verification process by the use of a functional model after the update.

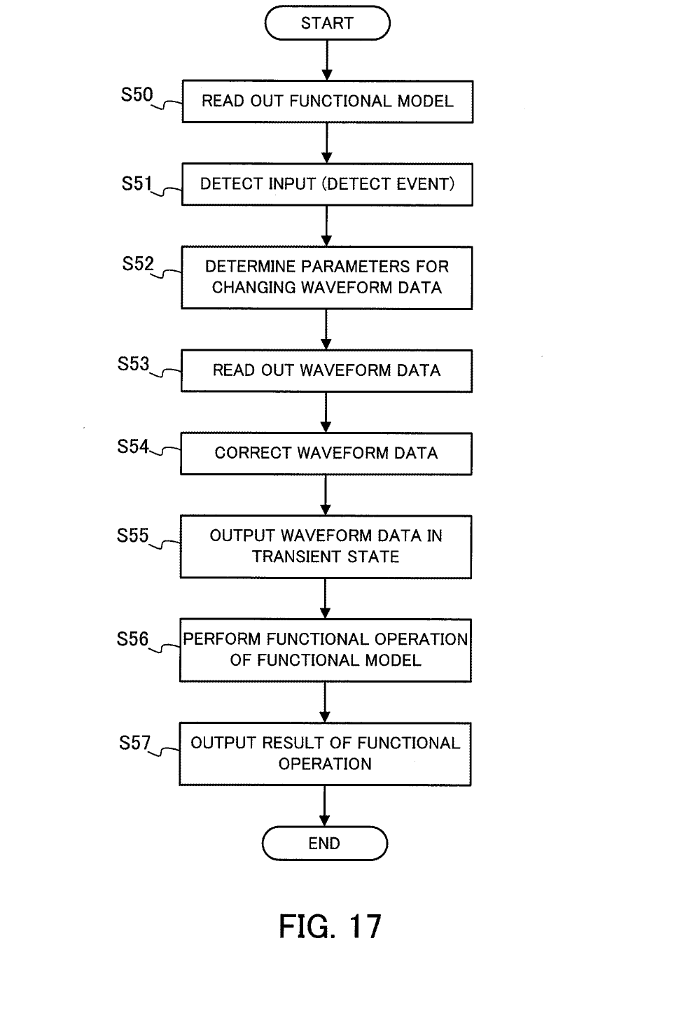

FIG. 17 is a flow chart of an example of a functional verification process in the circuit verification method according to the third embodiment.

(Step S50) The CPU 21 reads out a functional model stored in, for example, the HDD 23.

(Step S51) The CPU 21 detects input to the functional model (event).

(Step S52) The CPU 21 determines waveform data change parameters from an operating condition for a simulation and tendency data. The operating condition is designated, for example, by a user. The tendency data is read out from, for example, the HDD 23.

With the functional model indicated in FIG. 16, the waveform data change parameters (var_dratio, var_vratio, and var_tratio) corresponding to power-supply voltage AVD designated as an operating condition are determined in the code portion C. If there is tendency data corresponding to the designated operating condition, then the tendency data is used as the parameters. If there is no tendency data corresponding to the designated operating condition, then the parameters are found, for example, by a linear interpolation, an approximate expression, or the like.

The CPU 21 may find the value of output differential data corresponding to the designated operating condition in the same way by a linear interpolation, an approximate expression, or the like.

If plural operating conditions are taken into consideration, waveform data change parameters are obtained by multiplying together parameters found from tendency data influenced by the plural operating conditions.

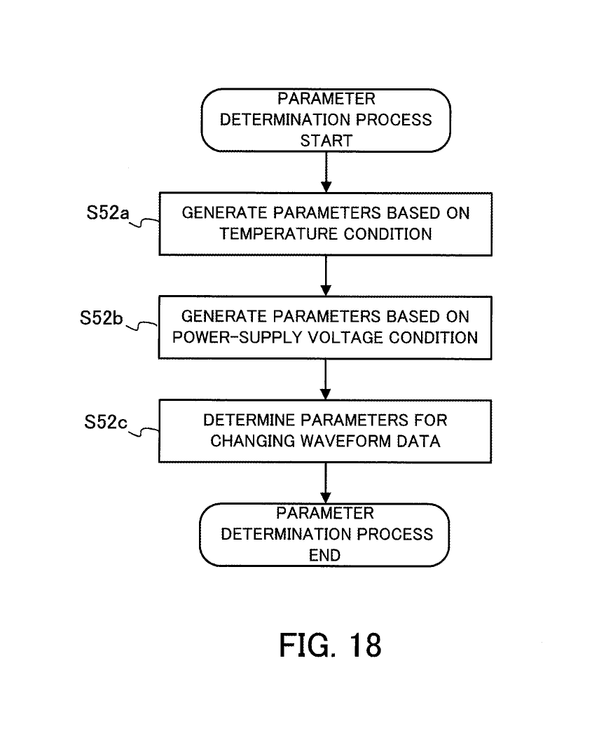

FIG. 18 indicates an example of a parameter determination method in which plural operating conditions are taken into consideration. FIG. 18 indicates an example of a parameter determination method in which two operating conditions, that is to say, a temperature condition and a power-supply voltage condition are taken into consideration.

(Step S52a) The CPU 21 generates parameters from tendency data corresponding to the temperature condition by the above linear interpolation or the like.

Of tendency data of the above three types, a delay time ratio and a setup time ratio depend on the temperature condition.

(Step S52b) The CPU 21 generates parameters from tendency data corresponding to the power-supply voltage condition by the above linear interpolation or the like. All tendency data of the above three types depends on the power-supply voltage condition.

(Step S52c) The CPU 21 multiplies together parameters found from tendency data influenced both by the temperature condition and by the power-supply voltage condition to determine waveform data change parameters. Of tendency data of the above three types, a delay time ratio and a setup time ratio are influenced by the temperature condition and the power-supply voltage condition, so waveform data change parameters are determined by multiplying together parameters found based on these operating conditions.

For example, it is assumed that a power-supply voltage of 4 V and a temperature of 20° C. are reference operating conditions. The CPU 21 multiplies a delay time ratio obtained at the time of the temperature being changed to 25° C. by a delay time ratio obtained at the time of the temperature being kept at 20° C. and power-supply voltage being changed to 5 V. In addition, the CPU 21 multiplies a setup time ratio obtained at the time of the temperature being changed to 25° C. by a setup time ratio obtained at the time of the temperature being kept at 20° C. and power-supply voltage being changed to 5 V. By doing so, two waveform data change parameters used at the time of the temperature being 25° C. and power-supply voltage being 5 V are found.

It is assumed that a voltage ratio, which is tendency data of the third type, does not depend on the temperature condition. In that case, a parameter found in step S52b on the basis of a voltage ratio obtained at the time of power-supply voltage being 5 V is a third waveform data change parameter used at the time of the temperature being 25° C. and power-supply voltage being 5 V.

The order of steps S52a and S52b may be reversed or steps S52a and S52b may be performed in parallel.

The following is a continuation of the description of the flow chart of FIG. 17.

(Step S53) The CPU 21 reads out waveform data in a transient state of a reference output signal stored in, for example, the HDD 23.

(Step S54) The CPU 21 corrects the waveform data in a transient state of the reference output signal, which it reads out, by the use of the waveform data change parameters, which it determines in step S52, to generate waveform data corresponding to the operating condition.

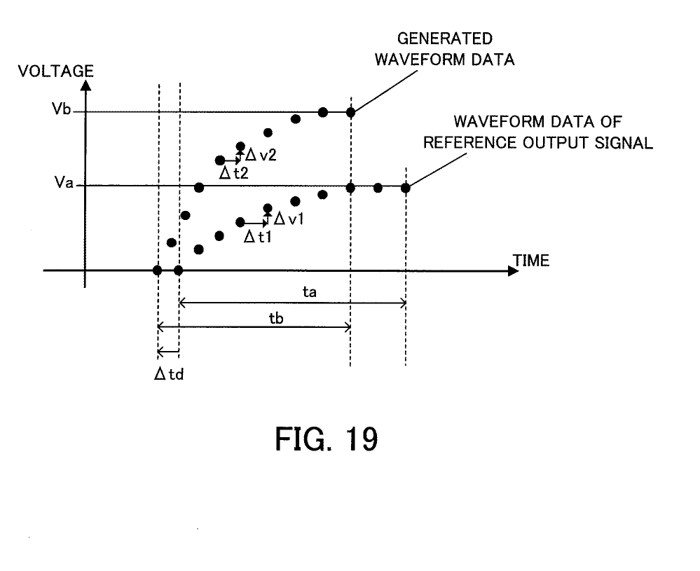

FIG. 19 indicates an example of a waveform data correction process. In FIG. 19, a horizontal axis indicates time and a vertical axis indicates voltage.

FIG. 19 indicates examples of waveform data of a reference output signal and waveform data generated on a designated operating condition. Time to indicates setup time of the reference output signal and time tb indicates setup time of an output signal generated on the designated operating condition. Voltage Va indicates a voltage value at a point at which a change in the waveform of the reference output signal ends, and voltage Vb indicates a voltage value at a point at which a change in the waveform of the output signal generated on the designated operating condition ends.

Waveform data change parameters are applied to the waveform data of the reference output signal. As a result, a delay amount is reduced by Δtd. Furthermore, sampling time Δt2 is tb/ta times sampling time Δt1 of the waveform data of the reference output signal. In addition, the value Δv2 of a change in voltage between data points is Vb/Va times the value Δv1 of a change in voltage between data points of the waveform data of the reference output signal.

(Step S55) The CPU 21 outputs the generated waveform data as an output signal in a transient state of the functional model.

(Step S56) The CPU 21 performs a functional operation of the functional model.

(Step S57) The CPU 21 outputs the result of the functional operation. At this time the CPU 21 may read out output differential data corresponding to the operating condition from, for example, the HDD 23 and correct the result of the functional operation by the use of the output differential data it reads out.

With the above circuit verification method according to the third embodiment the same effects that are achieved by the circuit verification method according to the first or second embodiment are obtained. Furthermore, with the circuit verification method according to the third embodiment tendency data corresponding to an operating condition is found and the waveform of a reference output signal is corrected on the basis of the tendency data. As a result, accurate circuit verification in which the operating condition is reflected is performed.

In addition, with the circuit verification method according to the third embodiment not waveform data but tendency data is stored according to operating conditions. This reduces the amount of data to be stored.

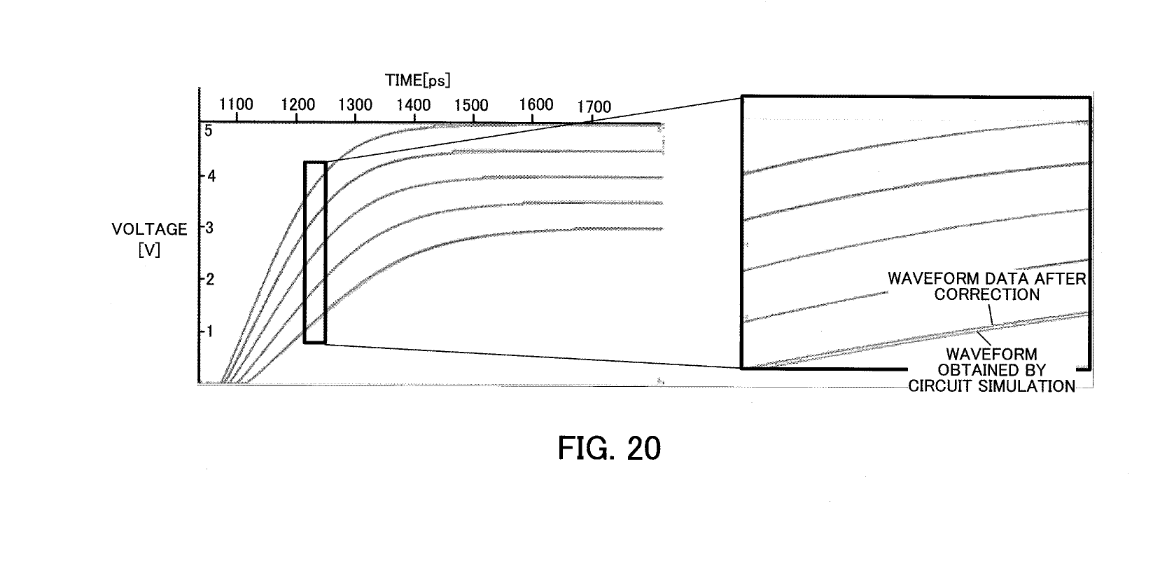

FIG. 20 indicates an example of a comparison between waveform data after correction obtained by the circuit verification method according to the third embodiment and a waveform obtained by a circuit simulation. In FIG. 20, a horizontal axis indicates time (ps) and a vertical axis indicates voltage (V).

FIG. 20 indicates examples of waveform data after correction obtained by the above functional verification at the time of power-supply voltage being changed to 3, 3.5, 4.5, and 5 V. In this case, an output signal obtained by doing a circuit simulation (SPICE) in which power-supply voltage is 4 V is used as reference. Waveform data after correction matches with great accuracy (with an error of not over ±2%) a waveform obtained by doing a circuit simulation in which power-supply voltage is 3, 3.5, 4.5, or 5 V.

The contents of the above processes can be realized with a computer. In that case, a program in which the contents of the functions of the circuit verification apparatus 10 or 20 has are described is provided. By executing this program on the computer, the above functions are realized on the computer. This program may be recorded on a computer readable record medium. A computer readable record medium may be a magnetic recording device, an optical disk, a magneto-optical recording medium, a semiconductor memory, or the like. A magnetic recording device may be a HDD, a flexible disk, a magnetic tape, or the like. An optical disk may be a DVD, a DVD-RAM, a CD-ROM, a CD-R(Recordable)/RW(ReWritable), or the like. A magneto-optical recording medium may be a MO or the like.

To place the program on the market, portable record media, such as DVDs or CD-ROMs, on which it is recorded are sold. Alternatively, the program is stored in advance in a storage unit of a server computer and is transferred from the server computer to another computer via a network.

When a computer executes this program, it will store the program, which is recorded on a portable record medium or which is transferred from the server computer, in, for example, its storage unit. Then the computer reads the program from its storage unit and performs processes in compliance with the program. The computer may read the program directly from a portable record medium and perform processes in compliance with the program. Furthermore, each time the program is transferred from the server computer, the computer may perform processes in order in compliance with the program it receives.

According to the disclosed circuit verification method, circuit verification apparatus, and program, the speed of circuit verification in which the operation of an actual device is reflected is increased.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A circuit verification method which makes a processor:
acquire waveform data of output in a transient state of a verification target circuit by a circuit simulation and store the waveform data in a memory; and
generate, at the time of detecting input to a functional model of the verification target circuit during functional verification performed by the use of the functional model, an output signal of the functional model by the use of the waveform data stored in the memory.

2. The circuit verification method according to claim 1 which makes the processor:
do a circuit simulation of the verification target circuit on plural operating conditions and acquire tendency data indicative of a tendency of a change of waveform data which is a circuit simulation result obtained on another operating condition in respect to waveform data which is a circuit simulation result obtained on a reference operating condition; and
correct the waveform data obtained on the reference operating condition at functional verification time on the basis of tendency data corresponding to a designated operating condition to generate an output signal of the functional model.

3. The circuit verification method according to claim 2, wherein the tendency data is a delay time ratio in the verification target circuit, a setup time ratio in the verification target circuit, or an output value ratio of the verification target circuit obtained from a circuit simulation result obtained on the reference operating condition and a circuit simulation result obtained on another operating condition.

4. The circuit verification method according to claim 2, wherein the tendency data is obtained from information at a point of an output signal of the verification target circuit obtained by a circuit simulation at which a maximum or minimum change occurs.

5. The circuit verification method according to claim 1 which makes the processor:
find an output signal of the functional model by a functional simulation and acquire a value differential between the output signal of the functional model and the waveform data at timing at which acquisition of the waveform data ends; and
correct the output signal of the functional model after application of the waveform data on the basis of the value differential at functional verification time.

6. The circuit verification method according to claim 5 which makes, at the time of detecting input to the functional model during the functional verification and the output signal of the functional model being greater than a threshold, the processor restrict application of the waveform data to the output signal of the functional model and correct the output signal of the functional model by the use of the value differential.

7. A circuit verification apparatus comprising:
a memory; and
a processor which:
acquires waveform data of output in a transient state of a verification target circuit by a circuit simulation and stores the waveform data in the memory; and
generates, at the time of detecting input to a functional model of the verification target circuit during functional verification performed by the use of the functional model, an output signal of the functional model by the use of the waveform data stored in the memory.

8. A computer-readable, non-transitory record medium storing a program which makes a computer:
acquire waveform data of output in a transient state of a verification target circuit by a circuit simulation and store the waveform data in a memory; and
generate, at the time of detecting input to a functional model of the verification target circuit during functional verification performed by the use of the functional model, an output signal of the functional model by the use of the waveform data stored in the memory.
